(19) United States
(12) Patent Application Publication
(10) Pub. No.: US 2006/0102441 A1
(43) Pub. Date: May 18, 2006

(54) Vibration dampener structure for archery bows

(76) Inventor: Charles Edward Nease, Salt Rock, WV (US)

Correspondence Address: STEVENS & SHOWALTER LLP, 7019 CORPORATE WAY, DAYTON, OH, 45459-4238, US

(21) Appl. No.: 11/267,468

(22) Filed: Nov. 4, 2005

Related U.S. Application Data
(60) Provisional application No. 60/625,461, filed on Nov. 5, 2004.

(51) Int. Cl. F16F 7/10; F41B 5/20

(52) U.S. Cl. 188/378; 124/89

(57) ABSTRACT

A vibration dampening structure for attachment to an elongated support structure subject to vibration. The dampening structure includes a body structure for absorbing vibrations in the support structure, and an elastomeric attachment structure connected to the body structure and extending around the support structure to provide a resilient connection between the body structure and the support structure. The body structure includes a body portion that is movable relative to the support structure in response to vibratory movement of the support structure. A pair of substantially similar body portions may be provided connected to each other to form a ring-like structure for attachment to an elongated support structure, such as an archery bow limb.

### CROSS REFERENCE TO RELATED APPLICATION

The present application claims the benefit of U.S. Provisional Application No. 60/625,461, filed Nov. 5, 2004, which is incorporated herein by reference.

### BACKGROUND OF THE INVENTION

1. Field of the Invention

The present invention relates to devices for dampening vibrations in vibrating structures and, more particularly, to a device attachable to an archery bow for dampening vibration in the bow.

2. Description of Related Art

Archery bows typically generate undesirable vibrations upon release of an arrow. Such vibrations may occur in both the bow limbs and the bow string, including bow string oscillations that generate undesirable noise. In addition to generating noise, the vibrations generated when shooting an arrow may substantially affect the accuracy of the shot.

Several devices have been proposed for reducing vibrations in archery bows. For example U.S. Pat. No. 6,298,842 discloses a decay pattern modifier for reducing the effects of vibrations generated when an arrow is released from an archery bow. The decay pattern modifier comprises a mushroom-shaped member including a cylindrical head and a cylindrical stem that is rigidly attached to a bow limb, where movement of the stem and head operate to modify the decay pattern of vibrations set up in the bow when an arrow is released.

U.S. Pat. No. 6,712,059 discloses another apparatus comprising a finned vibration damper for attachment to an archery bow. The damper includes a base and a plurality of substantially flat fins, where the base may comprise a wrap-around structure having alternating ribs and grooves at proximal and distal ends thereof. The ribs and grooves of one end engages complementary ribs and grooves of the other end to maintain the damper in place on the archery bow.

There is a continuing need for a device to dampen vibrations in an archery bow where the device provides a design for effectively dampening vibrations resulting from release of the arrow and where the device may be conveniently attached to the bow.

### SUMMARY OF THE INVENTION

In accordance with one aspect of the invention, a vibration dampening structure is provided for attachment to an elongated support structure subject to vibration. The dampening structure comprises a body structure for absorbing vibrations in the support structure, and an elastomeric attachment structure connected to the body structure and extending around the support structure to provide a resilient connection between the body structure and the support structure. The body structure includes a body portion that is movable relative to the support structure in response to vibratory movement of the support structure.

In accordance with another aspect of the invention, a vibration dampening structure is provided for attachment to an elongated support structure subject to vibration. The dampening structure comprises a body structure for absorbing vibrations in the support structure, and an elastomeric attachment structure connected to the body structure and extending around the support structure. The body structure comprises an elongated structure extending away from a connection to the attachment structure, the attachment structure including a portion for engaging the body structure to form an additional connection between the attachment structure and the body structure.

In accordance with a further aspect of the invention, a vibration dampening structure is provided for attachment to an elongated support structure subject to vibration. The dampening structure comprises a first dampening structure half having first and second ends, and including a first vibration dampening member. The dampening structure further comprises a second dampening structure half having first and second ends. The second end of the first dampening structure half may be detachably attached to the first end of the second dampening structure half, and the second end of the second dampening structure half may be detachably attached to the first end of the first dampening structure half to form a ring-like structure surrounding the support structure.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a perspective view illustrating a vibration dampener constructed in accordance with the present invention attached to the end of an archery bow limb;

FIG. 2 is a top plan view of a dampener half;

FIG. 3 is a side elevation view of a dampener half;

FIG. 4 is bottom plan view of a dampener half; and

FIG. 5 is a top plan view of an alternative embodiment of a dampener half

### DETAILED DESCRIPTION

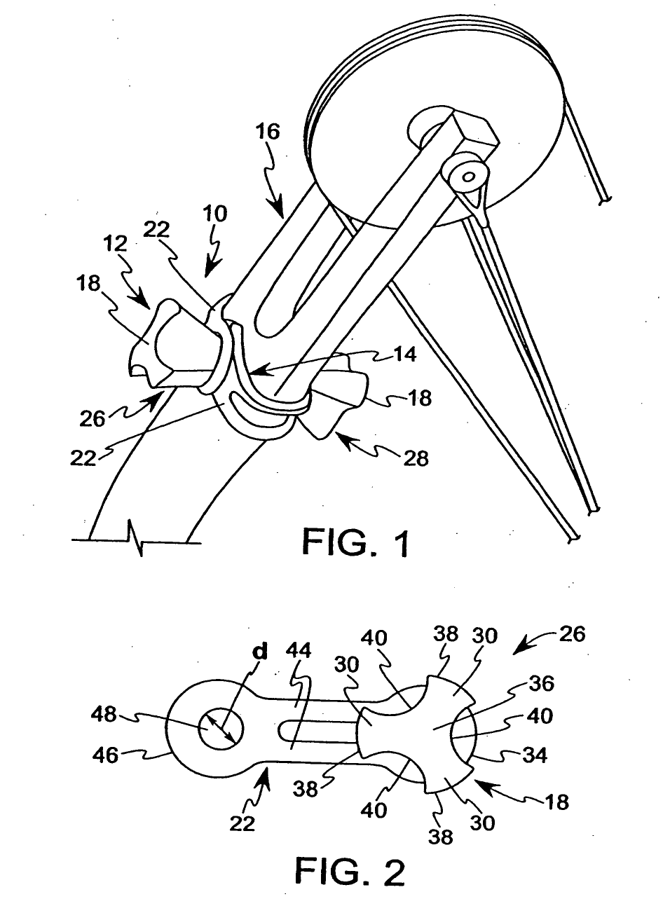

Referring to FIG. 1, the present invention is illustrated as being embodied by a vibration dampener 10 comprising a weight or body structure 12 and a resilient attachment structure 14. Devices such as the vibration dampener 10 are preferably attached to archery bow limbs, such as the bow limb 16 illustrated in FIG. 1, to reduce vibration and shock imparted to the archery bow, including the bow string, when an arrow is released.

The resilient attachment structure 14 comprises an elastomeric band-like structure which detachably and movably attaches the body structure 12 to the bow limb 16. In particular, the attachment structure 14 resiliently draws the body structure 12 into engagement with the bow limb 16, permitting movement and adjustment of the body structure 12 relative to the supporting bow limb 16.

The body structure 12 of the illustrated embodiment of the vibration dampener 10 is relatively more rigid than the attachment structure 14 and comprises a pair of body portions 18 located on opposite sides of the bow limb 16. Further, in a preferred embodiment, each body portion 18 is formed integrally with a respective attachment structure half 22 to define respective substantially identical dampener halves 26, 28. The dampener halves 26, 28 are formed of an elastomeric material such as rubber, or a comparable material having resilient elastomeric characteristics.

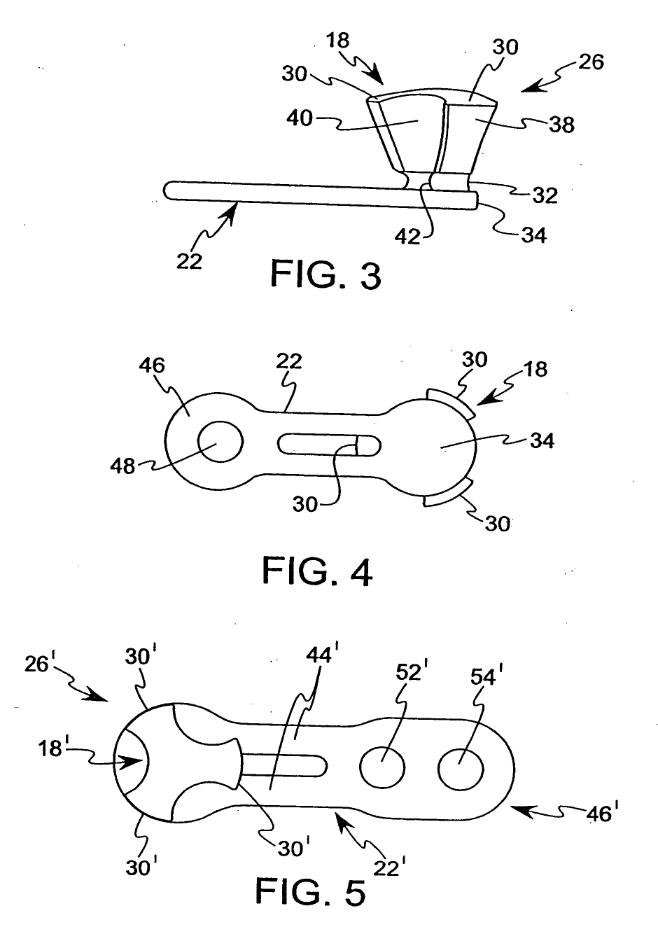

Referring to FIGS. 2-4, the dampener half 26 including the body portion 18 and attachment structure half 22 is illustrated. The body portion 18 is defined by a post-like structure comprising a plurality of lobes 30 circumferentially spaced from one another and extending longitudinally from a bottom portion 32 where the body portion 18 is formed integrally with a generally circular end portion 34 of the attachment structure half 22. The lobes 30 extend radially outwardly from a central portion 36 of the body portion 18, and include outer surfaces 38 which angle outwardly proceeding in a longitudinal direction from the bottom portion 32 toward a distal end of the body portion 18. The lobes 30 are separated by concave inner surfaces 40 of the body portion 18 which angle slightly inwardly proceeding in a direction from the bottom portion 32. In addition, each of the lobes 30 is formed with a groove 42 adjacent the junction between the bottom portion 32 and the end portion 34 of the attachment structure half 22.

The attachment structure half 22 comprises a pair of spaced band elements 44 which are of sufficiently narrow or small cross-section to be elastically stretchable. The band elements 44 are attached to a connector end 46. The connector end 46 defines an aperture 48, i.e., a through hole, having an inner diameter d which is generally equal to or slightly less than a diameter of the body portion 18 as defined at the grooves 42. The length of the band elements 44 is selected such that a distance from the center of the body portion 18 to the center of the aperture 48 in the connector end 46 is less than half the circumferential distance around the bow limb 16 to which the dampener 10 is to be mounted. As noted above, the dampener half 28 is substantially identical to the described structure for the dampener half 26.

In mounting the dampener 10 to a bow limb 16, the connector end 46 of dampener half 26 is positioned over the body portion 18 of dampener half 28, i.e., with the body portion 18 extending through the aperture 48, with the connector end 46 engaged in the grooves 42. The connector end 46 of the other dampener half 28 is positioned over the body portion 18 of the dampener half 26, with the connector end of the dampener half 28 engaged in the grooves 42 of the dampener half 26, and with the attachment structure halves 22 extending around the bow limb 16. It should be understood that the length of the band elements 44 is such that the band elements 44 are stretched around the bow limb 16 to cause lower surfaces of the end portions 34, below the body portions 18, to rest in engagement on adjacent surfaces of the bow limb 16.

The attachment of the body structure 12 to the bow limb 16 is such that the body portions 18 are not rigidly attached to the bow limb 16 and the lower surfaces of the end portions 34 may move relative to the adjacent surface of the bow limb 16, temporarily losing contact with the underlying supporting surface of the bow limb, in response to movement of the bow limb 16 when an arrow is shot to reduce or eliminate bow string oscillations during the shot sequence. Specifically, inertia forces acting on the body portions 18 may result in the body portions 18 moving or pivoting about the end portions 34, such that at least a portion of the lower surface of the end portion 34 may move out of contact with the surface of the bow limb 16 upon release of an arrow. Further, the resiliently moveable attachment of the body portions 18 alters the vibratory characteristics of the body portions 18 on the bow limb 16, as compared to rigid attachment of the body portions 18 to the bow limb. The loose or resilient attachment permits vibrations to be absorbed through the resilient movement associated with the resilient attachment structure 14 in addition to vibration absorbed by the body structure 12 itself.

The two piece construction of the vibration dampener 10, including two substantially identical pieces or dampener halves 26, 28 which attach to each other, facilitates mounting of the dampener 10 to a bow limb 16, without requiring disassembly of the bow limb 16 or use of fasteners or adhesives to associate and mount the dampener 10 to the bow limb 16. Further, the mounting structure 14 facilitates movement of the dampener 10 along the bow limb 16 after mounting, in that a non-rigid mounting is provided permitting sliding adjustment of the dampener 10.

Referring to FIG. 5, an alternative configuration for the dampener halves is illustrated by dampener half 26′ where elements corresponding to elements in the first described configuration of the dampener half 26 are labeled with the same reference numerals primed. In this configuration, the connector end 46′ comprises a plurality of apertures, illustrated here as a pair of apertures 52′, 54′. The body portion 18′ may be positioned through one of the plurality of apertures 52′, 54′ to provide a desired tension in the attachment structure half 22′. The plurality of apertures 52′, 54′ provide for adjustability in mounting the dampener to different structures having different circumferences. As in the previous configuration of the dampener half 26, the dampener half 26′ cooperates with an additional dampener half which may be substantially identical to the dampener half 26′.

It should be noted that although the vibration dampener is described with reference to dampening vibrations in an archery bow, the dampener may be provided on other structures subject to vibration. For example, the vibration dampener may be mounted to a component of a tree stand to damp out pinging sound of a metal tree stand structure. In addition, the vibration dampener may be mounted to additional structures that may be subject to vibrations, such as golf clubs, tennis racquets, baseball bats, or other structures.

It should also be understood that the invention is not limited to the particular structures illustrated herein for resilient or elastomeric attachment of a body structure to a support structure for damping vibrations present at the support structure. For example, the body structure may comprise a single body portion with the attachment structure provided for connection to the body portion at both ends of the attachment structure. Further, the attachment structure may be provided as a separate elastomeric component attachable to the body structure, and the vibration dampener may be formed of two non-identical structure halves for extending around a support structure, where at least one structure half may provide substantial vibration dampening. The subject two-part constructions may additionally incorporate alternative attachment structures for joining two halves of the vibration dampener for positioning on the support structure. Also, the structure of the body portion may have a different shape or configuration than that disclosed herein, and the body and attachment structures may be more or less resilient or elastic than is suggested by the particular embodiment disclosed herein. Additional variations of the vibration dampener will be apparent to one of ordinary skill in the art.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A vibration dampening structure for attachment to an elongated support structure subject to vibration, the dampening structure comprising:
a body structure for absorbing vibrations in the support structure;
an elastomeric attachment structure connected to said body structure and extending around the support structure to provide a resilient connection between said body structure and the support structure, said body structure including a body portion that is movable relative to the support structure in response to vibratory movement of the support structure.

2. The apparatus of claim 1 wherein said body structure comprises a pair of body portions located on opposite sides of the support structure.

3. The apparatus of claim 2 wherein said pair of body portions are connected to each other by said attachment structure.

4. The apparatus of claim 3 wherein each said body portion is formed with an attachment structure half to define a dampening structure half, said attachment structure half of each dampening structure half being detachably fastened to the body portion of the other dampening structure half.

5. The apparatus of claim 1 wherein said attachment structure comprises an elastically stretchable member.

6. The apparatus of claim 5 including a lower surface located below said body portion and said elastically stretchable member holds said lower surface positioned in engagement with a surface of said support structure, said lower surface being moveable out of engagement with said surface of said support structure support structure in response to said body portion moving when inertia forces act on said body portion.

7. The apparatus of claim 5 wherein a portion of said attachment structure defines an aperture, said body portion extending through said aperture to retain said attachment structure in engagement with said support structure.

8. The apparatus of claim 7 wherein said body portion is formed integrally with said attachment structure.

9. The apparatus of claim 1 wherein said body portion comprises an elongated body extending generally perpendicularly from said attachment structure and includes a plurality of lobes extending radially outwardly, said lobes separated by generally concave grooves.

10. A vibration dampening structure for attachment to an elongated support structure subject to vibration, the dampening structure comprising:
a body structure for absorbing vibrations in the support structure;
an elastomeric attachment structure connected to said body structure and extending around the support structure; and
said body structure comprising an elongated structure extending away from a connection to said attachment structure, and said attachment structure including a portion for engaging said body structure to form an additional connection between said attachment structure and said body structure.

11. The apparatus of claim 10 wherein said portion for engaging said body structure comprises structure defining at least one aperture, and said elongated structure passing through said at least one aperture.

12. The apparatus of claim 10 wherein said elongated structure comprises a plurality of lobes extending radially outwardly, and extending substantially along the length of said elongated structure.

13. The apparatus of claim 12 wherein said elongated structure comprises three lobes, each said lobe including an outer surface angling outwardly in a direction from said connection to said attachment structure to a distal end of said elongated structure.

14. The apparatus of claim 12 wherein said lobes are separated from each other by concave surfaces extending substantially the length of said elongated structure.

15. The apparatus of claim 10 including a lower surface located below said body structure and said elastomeric attachment structure holds said lower surface positioned in engagement with a surface of said support structure, said lower surface being moveable out of engagement with said surface of said support structure in response to said body structure moving when inertia forces act on said body structure.

16. A vibration dampening structure for attachment to an elongated support structure subject to vibration, the dampening structure comprising:
a first dampening structure half having first and second ends, and including a first vibration dampening member;
a second dampening structure half having first and second ends;
said second end of said first dampening structure half being detachably attached to said first end of said second dampening structure half, and said second end of said second dampening structure half being detachably attached to said first end of said first dampening structure half to form a ring-like structure surrounding said support structure.

17. The apparatus of claim 16 wherein said second dampening structure half includes a second vibration dampening member.

18. The apparatus of claim 17 wherein said first and second vibration dampening members are supported to extend in substantially opposite directions away from each other.

19. The apparatus of claim 17 wherein said first vibration dampening member comprises an elongated body portion located at said first end of said first dampening structure half, and said second vibration dampening member comprises an elongated body portion located at said first end of said second dampening structure half.

20. The apparatus of claim 16 wherein said second ends of said first and second dampening structure halves comprise an aperture forming an attachment structure for attachment to said first ends of said second and first dampening structure halves, respectively.
